(19) United States
(12) Patent Application Publication
(10) Pub. No.: US 2023/0258031 A1
(43) Pub. Date: Aug. 17, 2023

(54) LOCKING DEVICE FOR A BARN DOOR

(71) Applicant: ERIC MALZ, Mahwah, NJ (US)

(72) Inventor: ERIC MALZ, Mahwah, NJ (US)

(21) Appl. No.: 17/669,533

(22) Filed: Feb. 11, 2022

(51) Int. Cl. E05B 65/08; E05B 3/00; E05B 15/02; E05B 63/12

(52) U.S. Cl. CPC E05B 65/0811; E05B 3/003; E05B 15/022; E05B 63/126; E05B 63/127; E05B 65/087; E05Y 2900/132

(57) ABSTRACT

A locking device for a barn door mounted in the wall adjacent a side edge of the door when in the closed position. The lock includes an outer cylinder that passes through the wall. The ends of the outer cylinder are mounted to each side of the wall. An inner cylinder is provided that is axially and slidably disposed within the outer cylinder and has a length greater than the length of the outer cylinder. When so positioned, one end of the inner cylinder can extend from the surface of the wall to prevent the barn from sliding to an open position by contacting the side edge of the barn door. When slid in the opposite direction the inner cylinder disengages from contacting the side edge of the barn door to enable the barn door to slide to the open position. Optionally, a locking mechanism is provided to lock the barn door in the closed position.

### FIELD OF THE INVENTION

This invention relates to a privacy lock for barn doors. More particularly, this invention relates to a privacy lock device for barn doors installed within a building interior to separate enclosures, e.g., rooms, closets, within the building.

### BACKGROUND OF THE INVENTION

Sliding barn doors are popular fixtures inside homes or offices. Previously relegated to actual barns, sliding barn doors possess many advantages over more traditional doors that swing on hinges. Some advantages of sliding barn doors include ease of operation and minimal space requirements in comparison to hinged doors. As they do not swing open, sliding barn doors can be more easily utilized in small home spaces, such as bathrooms, or as room separators in small houses. In comparison to other types of sliding doors such as pocket doors, barn doors include decreased construction and installation costs, as well as immense flexibility in size, dimensions, design, and functionality. Because they are typically mounted on one or more tracks outside doorways, door frames or openings, sliding barn doors do not necessarily have to match the parameters of a door frame and can be adapted to almost any space and function as space separators, foundations for hangings such as artwork or mirrors, or even serve purely decorative purposes on their own.

More specifically, a barn door is mounted on a sliding track or other support, typically above the opening, but optionally on the bottom also, with the door suspended from this track or other sliding support. This support track extends over the door opening and to a lateral side of the door opening. The barn door slides on the track between an open position (where it is suspended from the track portions which are laterally spaced to the side of the door opening) to a closed position (where the door is suspended from the track where it is located directly above the door opening).

One problem with such barn doors is that they typically do not include locks associated there with. Many doorways benefit from having a door which is lockable, at least for privacy purposes, if not for full security purposes. Privacy locks are known for pivoting doors and pocket doors which include, for example, a handle which rotates and causes a mechanism to engage/lock and disengage/unlock the door. However such known locks have the handle/knob mounted to the door with the bolt engaging and disengaging with the doorway jam. Such known prior art locks are not effective with barn doors because the doors are not aligned and are offset from the door jam. Thus some other solution is needed for a barn door lock to provide the necessary privacy and security.

There is therefore a need for an easy and convenient privacy lock device to prevent the interior sliding barn doors from opening, locking the barn doors and to prevent the doors from inadvertently sliding off the support tracks.

The following references may be relevant to this invention:

U.S. Pat. No. 10,081,966 to Cheng

U.S. Pat. No. 11,047,151 to Cheng

U.S. Pat. No. 2,613,098 to Kleeberg

US Publication No. 2018/002336 to Groff

US Publication No. 2019/0301204 to Odom

Korean Publication KR940005315Y1

PRC Publication CN204266716U to Huang Yixue

PRC Publication CN211081298U to Li Fan

The following non-patent references may or may not be effective prior art.

Amazon.com: barn door latch (NP1)

https.//youtube.com/watch?v=EKzHDZ_8ceU, (NP2)

National Hardware N700-150 (NP3)

Renin Barn Door Easy Latch: https.//youtube.com/watch?v=LrKmwTu3log (NP4)

### BRIEF DESCRIPTION OF THE DRAWINGS

Further aspects, features and advantages of the present invention will become more apparent with reference to the following detailed description and the accompanying drawings. An embodiment of the present invention is illustrated in the accompanying drawings as an example and is not to be limited by the figures of the drawings. The drawings are not presented to scale but are used to illustrate the principles of the invention. In the drawings, like reference numbers indicate like elements.

FIG. 1 is a perspective view of a barn door BD slidably installed on a track T mounted to a wall W over an entranceway EW (not shown) in a closed position with the lock device of this invention 100 shown installed in the wall W in the locked position.

FIG. 2 is a perspective view of the barn door BD slidably installed on the track T mounted to the wall W over the entranceway EW in an open position with the lock device of this invention 100 shown installed on the wall W in the unlocked position.

FIG. 3 is a perspective view of the barn door BD from the other side of the entranceway EW slidably installed on the track T mounted to the wall W over the entranceway EW in the closed position with the lock device of this invention 100 shown installed in the wall W in the locked position.

FIG. 4 is a perspective view of the uninstalled lock device of this invention 100 from the rear side of the lock device 100.

FIG. 5 is a perspective view, similar to FIG. 4, of the uninstalled lock device of this invention 100 in a locked position from the front side of the lock device 100

FIGS. 6 is the front elevation view of the lock device of this invention 100 in an unlocked position.

FIG. 7 is the side elevation view of the lock device of this invention 100 in an unlocked position.

FIGS. 8 is a sectional view of the lock device of this invention 100 taken along line A-A of FIG. 4.

### SUMMARY OF THE INVENTION

This invention is directed to combination barn door and locking device for the barn door. The barn door covers a doorway surrounded by a wall, the wall having an inner surface and an outer surface. The barn door has a top edge and an opposed bottom edge and a first side edge and an opposed second side edge and is slidably supported, typically at the top edge of the barn door, by a track. The barn door is usually spaced apart a distance from the inner surface of the wall, and is slidable between a closed position blocking the doorway and an open position providing access through the doorway.

The locking device of this invention is mounted in the wall adjacent the first side edge of the barn door when the barn door is in the closed position. The lock comprises an outer cylinder having a first end and a second end and a length sufficient that passes through the wall. The first end of the outer cylinder is mounted to the inner surface of the wall and the second end of the outer cylinder is mounted to the outer surface of the wall. An inner cylinder is provided that is axially and slidably disposed within the outer cylinder. The inner cylinder has a length greater than the length of the outer cylinder so that when so positioned one end of the inner cylinder can extend from the inner surface of the wall and the other end of the inner cylinder can extend from the outer surface of the wall. A handle is mounted to each end of the inner cylinder.

When the barn door is in the closed position and one of the handles is used to axially slide the inner cylinder in the outer cylinder to extend the inner cylinder a distance from the inner wall, the barn door is prevented from sliding to the open position by the extended inner cylinder contacting the first side edge of the barn door.

Alternatively, when the barn door is in the closed position and is prevented from opening by the inner cylinder contacting the first side edge of the barn door, one of the handles may be used to axially slide the inner cylinder in the outer cylinder to extend the inner cylinder a distance from the outer surface of the wall to disengage the inner cylinder from contacting the first side edge to enable the barn door to slide to the open position. The barn door, which is spaced apart from the inner wall surface, when opened passes over the handle mounted on the end of the inner cylinder on the inside surface of the wall.

Optionally, a locking mechanism is provided to lock the barn door in the closed position.

Other features and advantages of the present invention will become apparent from the following more detailed description, taken in conjunction with the accompanying drawings, which illustrate, by way of example, the principles of the invention.

### DETAILED DESCRIPTION OF THE INVENTION

The invention has been described with reference to various specific and illustrative aspects of the present invention and techniques. However, it should be understood that many variations and modifications may be made while remaining within the spirit and scope of the invention. Many alternatives, modifications and variations will be apparent to those skilled in the art in light of the foregoing description. Accordingly, this invention is intended to embrace all such alternatives, modifications, and variations that fall within the spirit and scope of the description.

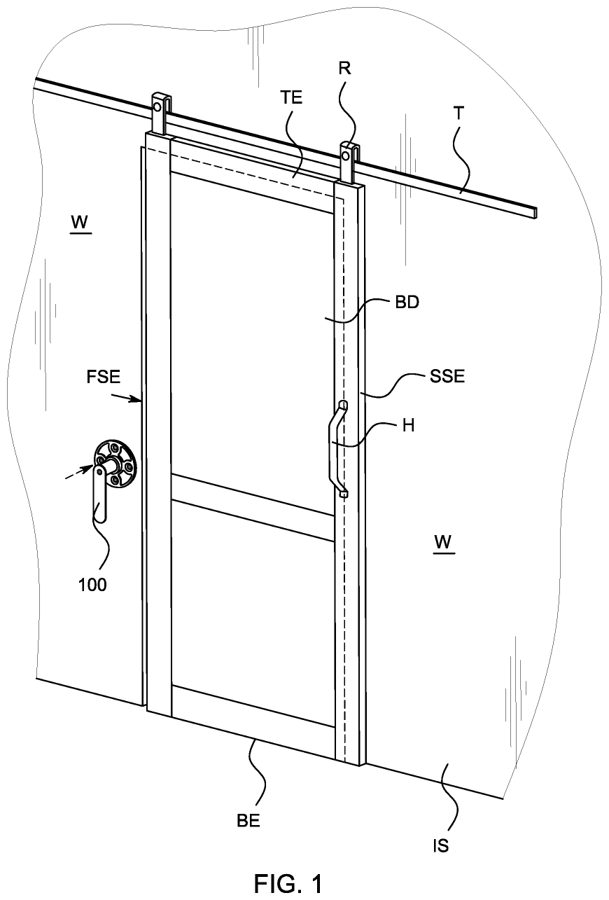

Referring to FIGS. 1-3, a combination barn door BD and locking device 100 for the barn door BD is provided. The barn door BD is used to close a doorway DW that is surrounded by a wall W. The wall W has an inner surface IS and on the other side of the wall W is an outer surface OS. Typically, the wall W is made of sheetrock mounted to studs or can be constructed of solid wood, e.g., a log cabin or actual barn.

The barn door BD has a top edge TE and an opposed bottom edge BE and a first side edge FSE and an opposed second side edge SSE. The barn door BD is slidably supported at the top edge TE of the barn door BD by a track T. Typically, as shown in FIGS. 1-3, the track T is mounted to the wall W, which in the example shown, is on the inner surface IS of the wall W. The barn door BD is suspended from the track T by rollers R that slide along the track T. Optionally, the barn door BD may have a lower track (not shown) to further secure and guide the barn door BD when opening or closing the doors.

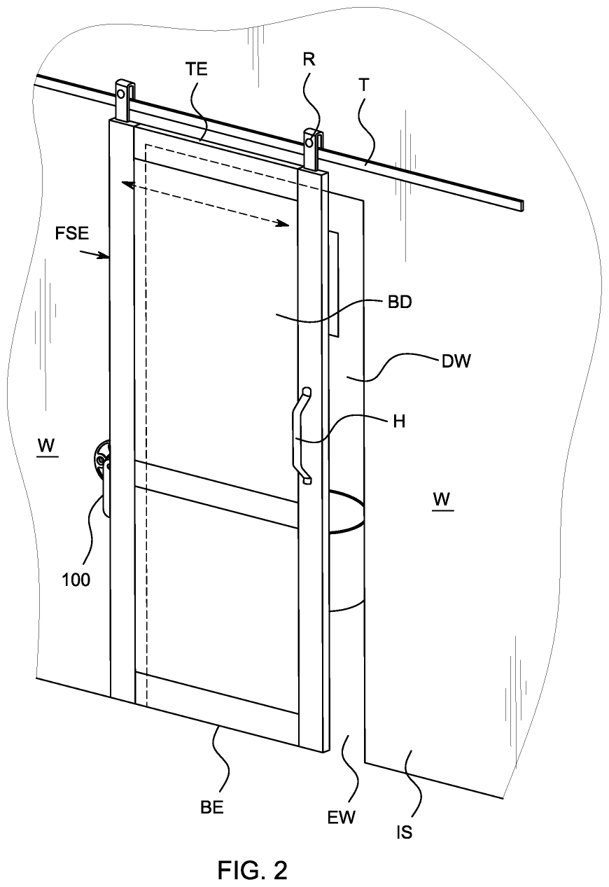

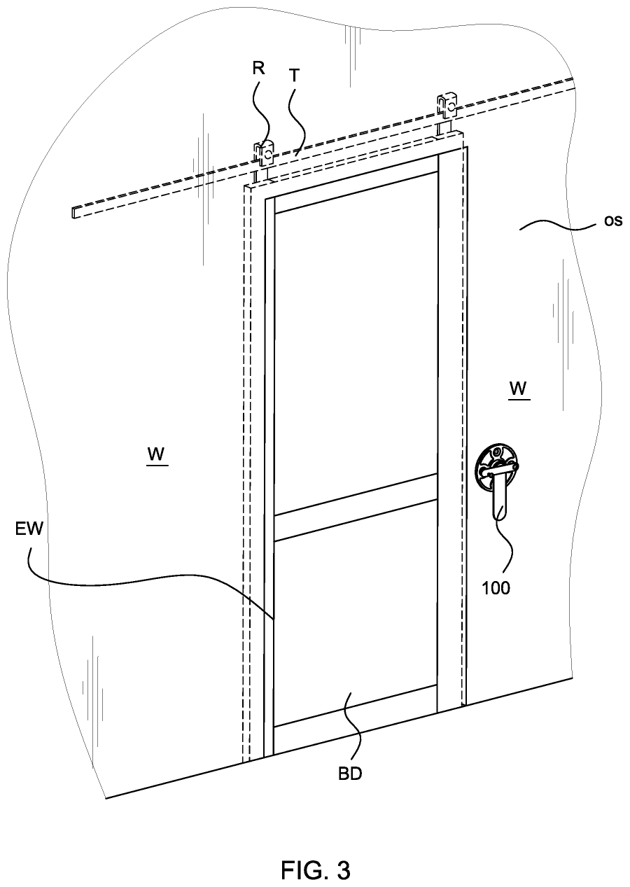

The barn door BD is spaced apart a distance from and the inner surface IS of the wall W to permit the barn door BD to slide on the track T without scraping the inner surface IS of the wall W. The barn door BD, as shown in FIGS. 1 and 2, has a handle 11 mounted near the second side edge SSE of the barn door BD to enable the barn door BD to slide between a closed position, i.e., FIGS. 1 and 3 blocking the doorway DW, and an open position, i.e., FIG. 2, to provide access through the doorway DW.

Still referring to FIGS. 1-3, the locking device 100 for the barn door BD is mounted in the wall W adjacent the first side edge FSE of the barn door BD when the barn door BD is in the closed position. The locking device 100 should be positioned at a height from the floor for easy access by the user.

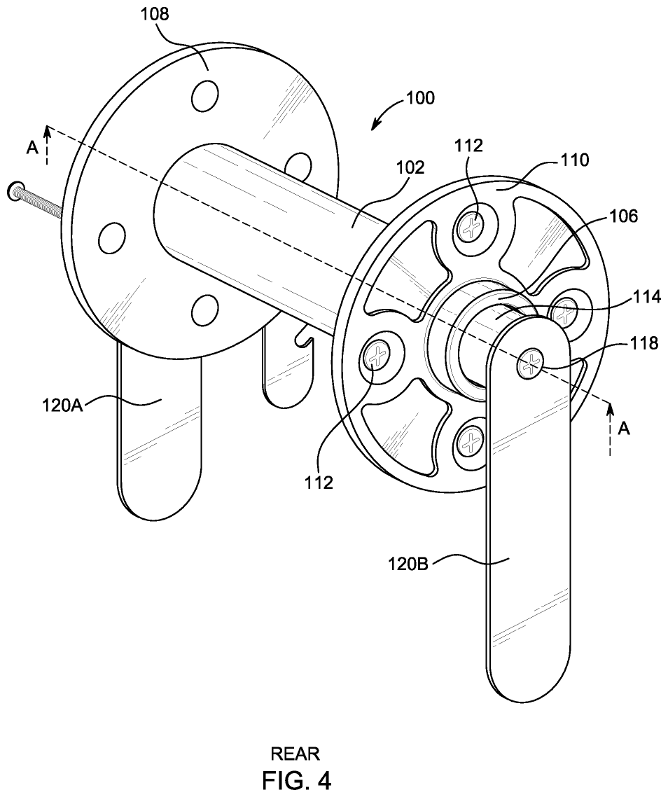

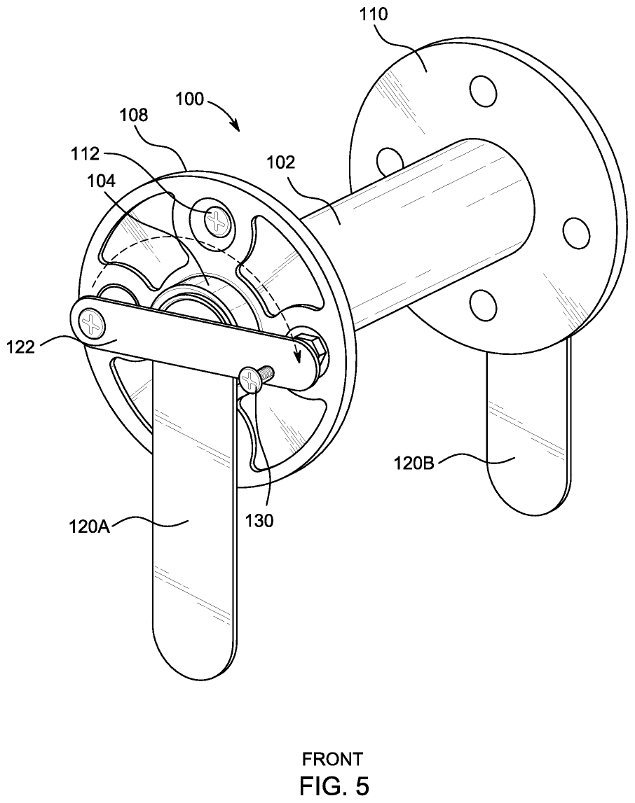

Referring to FIGS. 4 and 5 for example, the locking device 100 comprises an outer cylinder 102 having a central axis, A-A (FIG. 4) and a first end 104 and a second end 106. The outer cylinder 104 is of a length sufficient to pass through the wall W.

Installation of the locking device 100 is initially accomplished by cutting a hole through the wall W with a hole-saw of about the outer diameter of the outer cylinder 104. Broadly, the first end 104 of the outer cylinder 102 is mounted to the inner surface IS of the wall W and the second end 106 of the outer cylinder 102 is securely mounted to the outer surface OS of the wall W so that it is axially and circumferentially secured in the wall.

Any means may be used, however in the preferred embodiment depicted in the FIGS. the first end 104 and second end 106 of the outer cylinder 102 includes a first flange 108 mounted to the first end 104 of the outer cylinder 102 which is in turn mounted to the inner surface IS of the wall W. Likewise, the second end 106 of the outer cylinder 102 includes a second flange 110 mounted to the second end 104 of the outer cylinder 102 which is in turn mounted to the outer surface OS of the wall W. After the outer cylinder 102 is inserted in the wall W, the first and second flanges, 108 and 110 may be removably and threadably secured or mounted to the respective ends 104, 106, of the outer cylinder 102. The outer cylinder 102 and flanges 108, 110 may be made of a metal, e.g., steel, iron, or molded from plastic.

As depicted in FIGS. 4-6, the flanges 108, 110 may be secured to the inner surface IS and outer surface OS of the wall W by screws 112. Optionally, the flanges 108, 110 may be secured to the surfaces IS, OS by gluing them to the surfaces IS, OS.

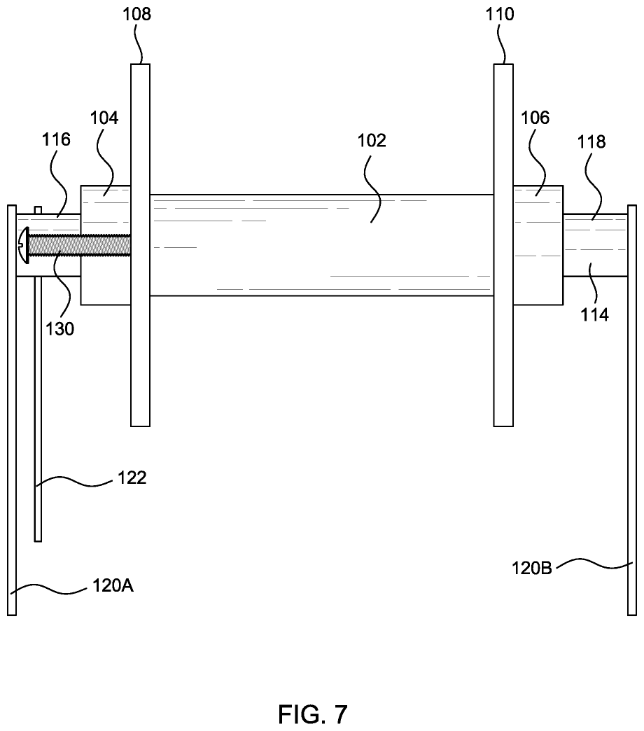

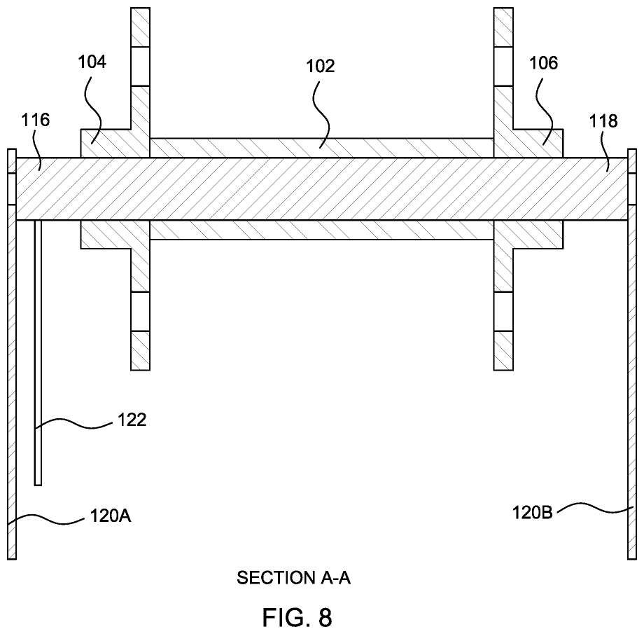

The locking device 100 further includes an inner cylinder 114 that is axially and slidably disposed within the outer cylinder 102. The inner cylinder 114 has a length greater than the length of the outer cylinder 102, see FIGS. 7 and 8. The inner cylinder 114 has a first end 116 that can be extended from the inner surface IS of the wall W and a second end 118 that can be extended from the outer surface OS of the wall W.

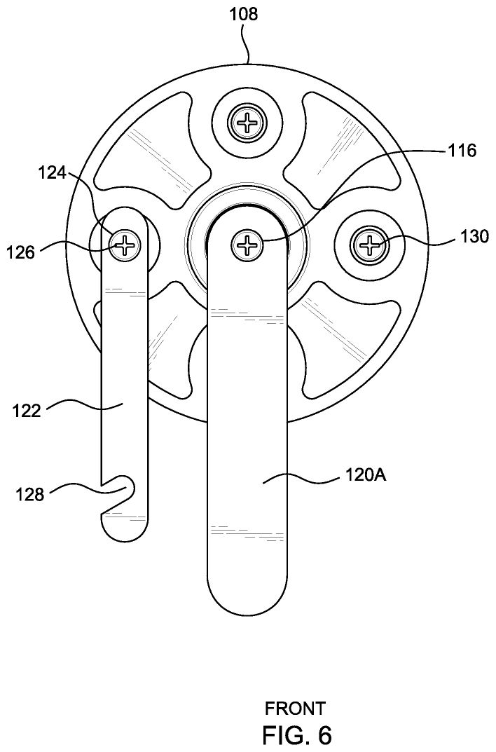

A handle 120A and 120B is mounted to each end of the inner cylinder 114. These handles 120A and 120B may be secured to the ends of the inner cylinder 114 after placement of the inner cylinder 114 in the outer cylinder 102, see FIGS. 4 and 6. The handles 120A and 120B are to assist in axially sliding the inner cylinder 114 in the outer cylinder 102 to extend the inner cylinder 114 from the inner surface IS and/or outer surface OS from either side of the wall to prevent or permit the barn door BD to open or close. In the embodiment depicted the handles 120A and 120B are elongated members mounted to the ends of the inner cylinder 114 which are easy to grasp by the user. In practice the handles may be spherical and/or decorative the only limitation is that they be easy to grasp for maneuvering the inner cylinder 114 to the appropriate position.

Referring to FIGS. 3, 5, 6 and 7 an elongated lock member 122 is pivotally mounted on one end 124 at a pivot location 126 to the second flange 106 that is mounted to the outer surface OS of the wall W. The pivot location 126 is off-center from the axis A-A of the outer cylinder 102. The other end of the elongated lock member 122 includes a first latch member 128 that in the embodiment depicted, is a U-shaped notch. A second latch member 130 is mounted on the second flange 106 mounted to the outer surface OS of the wall W diametrically opposite the pivot location 126 of the elongated lock member 122. In the embodiment depicted, the second latch member 130 is a screw that extends from the second flange 108. The first latch member 128, the U-shaped notch, and second latch member 130, the extended screw, matingly engage each other.

This is best seen in FIG. 5. When the first latch member 128 and the second latch member 130 are engaged, the elongated lock member 122 overlays the second end 118 of the inner cylinder 114. This prevents the inner cylinder 114 from extending from the second flange 110 mounted to the outer surface OS maintaining the inner cylinder 114 in the extended position from the inside surface IS to maintain the barn door BD locked.

Referring to FIG. 3, when the barn door ED is in the closed position and one of the handles 120A, 120B is used to axially slide the inner cylinder 114 in the outer cylinder 102 to extend the first end 116 of the inner cylinder 114 from the inner surface IS, the barn door BD is prevented from sliding to the open position by the first end 116 of the inner cylinder 114 that extends from the inner surface IS contacting the first side edge FSE of the barn door BD.

When the elongated lock member 122 is pivoted to engage the first latch member 128 with the second latch member 130, the elongated lock member 122 overlays the second end 118 of the inner cylinder 114 to prevent the first end 116 of the inner cylinder 114 from extending from the second flange 110 mounted to the outer surface OS to thereby lock the barn door BD.

Likewise, to unlock the barn door BD when the barn door BD is in the closed position and is prevented from opening by the first end 116 of the inner cylinder 114 contacting the first side edge FSE of the barn door BD, the elongated lock member 122 may be pivoted to disengage the first latch member 128 from the second latch member 130. Subsequently, one of the handles 120A, 120B is used to axially slide the inner cylinder 114 in the outer cylinder 102 to extend the inner cylinder 114 from the outer surface OS to enable the barn door BD to slide to the open position, the barn door spaced apart from the inner surface passing over the handle 120A mounted on the end of the inner cylinder 114 on the inside surface of the wall to thereby unlock the barn door.

As indicated previously, installation of the of this locking device 100 invention is relatively easy by cutting a hole through the wall W with a hole-saw of about the outer diameter of the outer cylinder 104. The first and second flanges, 108 and 110 may be threadably secured or mounted to the respective ends 104, 106, of the outer cylinder 102 after the outer cylinder 102 is inserted in the wall W and the flanges 108, 110 screwed to the surfaces of wall IS, OS. The inner cylinder 114 is then inserted in the outer cylinder 102. The handles 120A and 120B are each mounted to each end of the inner cylinder 114.

The locking device 100 of this invention may be made of a metal, e.g., steel, iron, or molded from plastic.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

ELEMENTS

| Part No. | Element Description |
|---|---|
| BD | Barn Door |
| T | Track mounted to wall W |
| W | Wall on which barn door BD and |
| | lock 100 are installed. |
| IS | Inner surface of wall W |
| OS | Outer surface of wall W |
| TE | Top edge of barn door BD |
| BE | Bottom edge of barn door BD |
| FSE | First side edge of barn door BD |
| SSE | Second side edge of barn door BD |
| H | Handle on barn door BD |
| A-A | Central axis for cylenders |
| 100 | Locking device |
| 102 | Outer cylinder |
| 104 | First end of outer cylinder 102 |
| 106 | Second end of outer cylinder 102 |
| 108 | first flange mounted to the inner |
| | surface IS of the wall W |
| 110 | second flange mounted to the outer |
| | surface of the wall |
| 112 | Screws securing flanges 108, 11 |
| 114 | Inner cylinder |
| 116 | First end of inner cylinder 114 extends |
| | from inner surface IS |
| 118 | Second end of inner cylinder 114 extending |
| | from outer surface OS |
| 120A & B | Handle mounted to the inner cylinder 114 |
| 122 | Elongated lock member |
| 124 | One end of elongated lock member 124 |
| 126 | Pivot location for mounting elongated |
| | lock member 122 |
| 128 | First latch member on other end of |
| | elongated lock member 124 |
| 130 | Second latch member |

1. A combination barn door and locking device for the barn door, comprising:
a doorway surrounded by a wall, the wall having an inner surface and an outer surface;
a barn door having a top edge and an opposed bottom edge and a first side edge and an opposed second side edge, the barn door slidably supported at the top edge of the barn door a spaced apart distance from the inner surface of the wall, wherein the barn door is slidable between a closed position blocking the doorway and an open position providing access through the doorway;
a locking device for the barn door mounted in the wall adjacent the first side edge of the barn door when the barn door is in the closed position, the locking device comprises an outer cylinder having a first end and a second end and a length sufficient to pass through the wall, wherein the first end of the outer cylinder is mounted to the inner surface of the wall and the second end of the outer cylinder is mounted to the outer surface of the wall;
an inner cylinder axially and slidably disposed within the outer cylinder, the inner cylinder having a length greater than the length of the outer cylinder, one end of the inner cylinder extending from the inner surface of the wall and the other end of the inner cylinder extending from the outer surface of the wall;
a handle mounted to each end of the inner cylinder;
wherein when the barn door is in the closed position and one of the handles is used to axially slide the inner cylinder in the outer cylinder to extend the inner cylinder from the inner wall, the barn door is prevented from sliding to the open position by the extended inner cylinder contacting the first side edge of the barn door; and
when the barn door is in the closed position and is prevented from opening by the inner cylinder contacting the first side edge of the barn door, one of the handles is used to axially slide the inner cylinder in the outer cylinder to extend the inner cylinder from the outer wall to enable the barn door to slide to the open position, the barn door spaced apart from the inner wall passing over the handle mounted on the end of the inner cylinder on the inside surface of the wall.

2. A combination barn door and locking device for the barn door, comprising:
a doorway surrounded by a wall, the wall having an inner surface and an outer surface;
a barn door having a top edge and an opposed bottom, edge and a first side edge and an opposed second side edge, the barn door slidably supported at the top edge of the barn door a spaced apart distance from and the inner surface of the wall, wherein the barn door is slidable between a closed position blocking the doorway and an open position providing access through the doorway;
a locking device for the barn door mounted in the wall adjacent the first side edge of the barn door when the barn door is in the closed position, the locking device comprises:
an outer cylinder having an axis, a first end and a second end and a length sufficient to pass through the wall, wherein the first end of the outer cylinder includes a first flange mounted to the inner surface of the wall and the second end of the outer cylinder includes a second flange mounted to the outer surface of the wall:
an inner cylinder axially and slidably disposed within the outer cylinder, the inner cylinder having a length greater than the length of the outer cylinder, the inner cylinder having a first end extending from the inner surface of the wall and a second end extending from the outer surface of the wall;
a handle mounted to each end of the inner cylinder;
an elongated lock member pivotally mounted on one end to the second flange mounted to the outer surface of the wall at a pivot location off-center from the axis of the outer cylinder, the other end of the elongated lock member including a first latch member;
a second latch member mounted on the second flange mounted to the outer surface of the wall diametrically opposite the pivot location of the elongated lock member, the first latch member and second latch member matingly engagable with each other, wherein when the first latch member and the second latch member are engaged the elongated lock member overlays the second end of the inner cylinder to prevent the inner cylinder from extending from the second flange mounted to the outer wall;
wherein when the barn door is in the closed position and one of the handles is used to axially slide the inner cylinder in the outer cylinder to extend the inner cylinder from the inner wall, the barn door is prevented from sliding to the open position by the extended inner cylinder contacting the first side edge of the barn door; and
when the elongated lock member is pivoted to engage the first latch member with the second latch member, the elongated lock member overlays the end of the inner cylinder to prevent the end of the inner cylinder from extending from the second flange mounted to the outer wall to thereby lock the barn door; and
when the barn door is in the closed position and is prevented from opening by the inner cylinder contacting the first side edge of the barn door, the elongated lock member is pivoted to disengage the first latch member from the second latch member and one of the handles is used to axially slide the inner cylinder in the outer cylinder to extend the inner cylinder from the outer wall to enable the barn door to slide to the open position, the barn door spaced apart from the inner wall passing over the handle mounted on the end of the inner cylinder on the inside surface of the wall to thereby unlock, the barn door.

3. The combination barn door and locking device for the barn door of claim 1, wherein the barn door is slidably supported at the bottom edge of the barn door.

4. The combination barn door and locking device for the barn door of claim 1, wherein the first flange and, the second flange are removably and threadably mounted to the ends of the outer cylinder.

5. The combination barn door and locking device for the barn door of claim 1, wherein the handles are removably mounted to the ends of the inner cylinder.

6. A locking device for a barn door mounted on a wall, comprising:
an outer cylinder having an axis, a first end and a second end and of a length sufficient to pass through the wall, wherein the first end of the outer cylinder includes a first flange for mounting to one side of the wall and a second end of the outer cylinder includes a second flange mounting to the other side of the wall;
an inner cylinder axially and slidably disposed within the outer cylinder, the inner cylinder having a length greater than the length of the outer cylinder, a removable handle mounted to each end of the inner cylinder;
an elongated lock member pivotally mounted on one end to the second flange at a pivot location off-center from the axis of the outer cylinder, the other end of the elongated lock member including a first latch member;
a second latch member mounted on the second flange diametrically opposite the pivot location of the elongated lock member, the first latch member and second latch member matingly engagable with each other, wherein when the first latch member and the second latch member are engaged the elongated lock member overlays the second end of the inner cylinder to prevent'the inner cylinder from extending from the second flange;

7. The locking device for the barn door of claim 6, wherein the first flange and the second flange are removably and threadably mounted to the ends of the outer cylinder.
